(19) United States
(12) Patent Application Publication
(10) Pub. No.: US 2009/0063697 A1
(43) Pub. Date: Mar. 5, 2009

(54) File transfer system and method for same

(75) Inventor: Akihito Fukao, Chino-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/231,509

(22) Filed: Sep. 3, 2008

(30) Foreign Application Priority Data
Sep. 4, 2007 (JP) 2007-228789
Sep. 4, 2007 (JP) 2007-228796

(51) Int. Cl. G06F 15/16

(52) U.S. Cl. 709/232

(57) ABSTRACT

A file transfer system includes transfer requesting terminals, a transfer responding terminal, and a mediating server. If a transfer responding terminal sends to the mediating server a request for session setup with the transfer responding terminal, the mediating server forwards the connection request to the transfer responding terminal irrespective of whether a session has been set up between any one of the transfer requesting terminals and the transfer responding terminal. The transfer responding terminal returns a connection acceptance response to the mediating server including location of a file transfer destination if a number of existing connections is less than its maximum number, or returns a connection refusal response if the number of connections is equal to the maximum number. The mediating server forwards the connection response to the transfer requesting terminal that originally sent the connection request. The transfer requesting terminal sends a file to the transfer destination in accordance with a data transfer protocol upon receiving the connection acceptance response.

### CROSS-REFERENCE TO RELATED APPLICATIONS

The present application claims the priority based on Japanese Patent Applications No. 2007-228789 and No. 2007-228796 both filed on Sep. 4, 2007, the disclosures of which are hereby incorporated by reference in their entireties.

### BACKGROUND OF THE INVENTION

1. Field of the Invention

The present invention relates to a technology for transferring files over a network, and particularly to a technology adapted to enable simultaneous high-speed file transfer from a plurality of terminals to a particular terminal. Herein, the term “file” is used to include data that represents text, images, a combination thereof, or other information, saved in a prescribed file format.

2. Description of the Related Art

In conventional practice, a communication platform is set up using SIP (Session Initiation Protocol; a protocol utilized in fax, IP telephony, and other telephony networks) as the protocol for setting up the session, and on this platform non-voice data communication is then carried out according to another protocol known as RTP (Real-time Transport Protocol) by which the data for transfer is handled as if it were voice data (pseudo voice communication).

However, since RTP has the limitations of fixed packet length and packet transmission intervals, even where data communication takes place over a high-speed communication platform, if the pseudo voice communication is implemented in accordance with RTP it will not be possible to sufficiently take advantage of the high speed capabilities of the communication platform, with the resultant problem of inability to achieve high-speed data communications.

In order to address this problem, there have been contemplated technologies such as that disclosed in JP2004-147128A wherein high-speed data communication is carried out using the HTTP protocol, rather than by carrying out data communication through the pseudo voice communication.

However, while the technology disclosed in JP2004-147128A does make possible high-speed file transfer, it nevertheless has the limitation described below. Specifically, the technology has the limitation that, insofar as the signaling protocol SIP is used as the protocol for setting up a session between terminals, only a single session is allowed for each terminal. This limitation means that, for example, if a particular server terminal is requested to set up sessions substantially simultaneously with a plurality of client terminals for the purpose of file transfer, since the server terminal can only set up a session with a client terminal one at a time, the other client terminals may experience interrupted communications owing to a “busy line.” Thus, despite the high-speed data capability of the communication platform, it will not be possible to fully utilize this capability.

### SUMMARY OF THE INVENTION

An object of the present invention is to provide a technology to carry out simultaneous high-speed file transfer from a plurality of terminals to a particular terminal on a communication platform in which a signaling protocol is employed as the protocol for setting up a session between terminals.

According to an aspect of the present invention, there is provided a file transfer system for transferring files over a network. The file transfer system includes a plurality of transfer requesting terminals, a transfer responding terminal, and a mediating server that mediates session setup between the transfer requesting terminals and the responding terminal. If a transfer responding terminal sends, to the mediating server via the network according to a signaling protocol, connection request information that indicates a request for session setup with the transfer responding terminal, the mediating server forwards the connection request information to the transfer responding terminal via the network irrespective of whether a session has been set up between any one of the transfer requesting terminals and the transfer responding terminal. The transfer responding terminal returns connection response information to the mediating server via the network that indicates a connection acceptance response and that includes location information indicating a file transfer destination on the network if a number of connections for which a session has already been established is less than a maximum number of possible simultaneous connections, or the transfer responding terminal returns connection response information to the mediating server that indicates a connection refusal response if the number of connections is equal to the maximum number. The mediating server which received the connection response information from the transfer responding terminal forwards the connection response information to the transfer requesting terminal that originally sent the connection request information. The transfer requesting terminal which received the connection response information sends a file to the transfer destination indicated by the location information included in the connection response information in accordance with a data transfer protocol if the connection response information indicates the connection acceptance response.

According to the file transfer system, the mediating server will be able to transfer the connection request to the responding terminal irrespective of whether a session between the responding terminal and any one of the transfer requesting terminals is already set up. The responding terminal will be able to accept the connection and set up a session provided that the maximum number of connections at the file transfer destination has not been reached. The transfer requesting terminal that initiated setup of the session will thus be able to transmit files to the transfer destination in accordance with a data transfer protocol, thereby making it possible to carry out simultaneous high-speed file transfer from a plurality of terminals to a particular terminal, on a communication platform in which a signaling protocol for setting up a session between terminals has been utilized.

As location information on the network, it would be possible to utilize IP (Internet Protocol) addresses, MAC (Media Access Control) addresses, or the like.

It is also to be understood that the present invention is not limited to a machine such as a file transfer system, a transfer requesting terminal, and a transfer responding terminal, or to a method such as a file transfer method; and may be embodied in various other modes such as a computer program constituting such a method or machine, or a recording medium having such a computer program recorded thereon.

### BRIEF DESCRIPTION OF THE DRAWINGS

FIG. 1 is a block diagram depicting a simplified configuration of a file transfer system according to an embodiment of the present invention;

FIG. 2 is a block diagram depicting the main components of the requesting terminal;

FIG. 3 is a block diagram depicting the main components of the responding terminal;

FIG. 4 is a block diagram depicting the main components of the SIP server;

FIG. 5 is a block diagram depicting the main components of the file receiving service terminal;

FIG. 6 is a flowchart of a process executed by a requesting terminal for sending a file;

FIG. 7 is a flowchart of a process executed by the SIP server in sending a file from a requesting terminal to a substitute receiver of a responding terminal;

FIG. 8 is a flowchart of a process executed by the responding terminal in the event that a connection request source terminal executes sending of a file to a substitution receiver for the responding terminal;

FIG. 9 illustrates overall system operation where the first connection request source terminal has issued a connection request;

FIG. 10 illustrates overall system operation where the second connection request source terminal has issued a connection request; and

FIG. 11 illustrates overall system operation where the third connection request source terminal has issued a connection request.

### DESCRIPTION OF THE PREFERRED EMBODIMENT

The embodiments of the present invention will be described below, in the indicated order.
A. System Configuration:
B. System Operation:
C. Advantages of the Embodiment:
D. Modified Embodiments:

### A. System Configuration

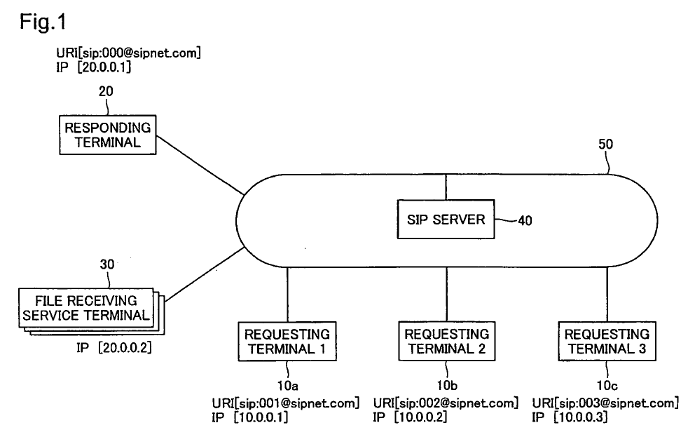

FIG. 1 is a block diagram depicting a simplified configuration of a file transfer system according to an embodiment of the present invention.

The file transfer system includes three requesting terminals 10a, 10b, 10c capable of initiating file transfer requests; a responding terminal 20 capable of executing processes in response to connection requests from the requesting terminals 10a, 10b, 10c; a file receiving service terminal 30 that is capable in place of the responding terminal 20 of receiving files sent by the requesting terminals 10a, 10b, 10c; and an SIP (Session Initiation Protocol) server 40 that is administered by the network service provider. These devices 10a, 10b 10c, 20, 30, and 40 are interconnected over a broadband network 50 which may include the Internet. In the following description, in instances where there is no particular need to distinguish among the three requesting terminals 10a, 10b 10c, these will be denoted simply as “requesting terminals 10,” omitting the respective symbols a, b, and c. While in FIG. 1 three requesting terminals 10 are depicted for convenience, no particular limitation is imposed thereby, and the system configuration could include any number of requesting terminals.

### A1. Requesting Terminals

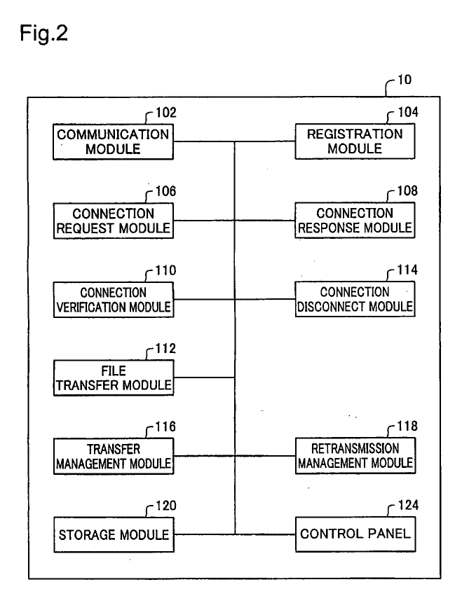

FIG. 2 is a block diagram depicting the main components of the requesting terminal 10 in FIG. 1. The requesting terminal 10 is constituted by a computer system, and has a number of function blocks for carrying out various processes and controls. Specifically, as shown in FIG. 2, there are provided the function blocks of a communication module 102, a registration module 104, a connection request module 106, a connection response module 108, a connection verification module 110, a file transfer module 112, a connection disconnect module 114, a transfer management module 116, a retransmission management module 118, a storage module 120, and a control panel 122.

The communication module 102 handles transfer of various kinds of data, files, information and so on vis-à-vis other devices on the network.

The registration module 104 registers, as registration information in the SIP server 40, URI (Uniform Resource Identifier) information that identifies the requesting terminal 10, and its own IP (Internet Protocol) address information, which has been pre-assigned by the network service provider for the purpose of setting up sessions among devices via the SIP server 40. This registration process will be executed at boot-up of the terminal, for example. The registration process may also be carried out on a periodic basis. The URI may be composed of a scheme, user name, and domain name, such as “sip:user@ host” for example. Here, “sip:” is an identifier (scheme) indicating the SIP protocol; “user” is the SIP user name; and “host” is the SIP domain name. A number, such as an IP telephony phone number etc., or a nickname, could be used as the user name “user”. The same domain name or IP address as the connected SIP server could be used as the SIP domain name “host”. In the example of FIG. 1, respective user names “user” of “001”, “002”, and “003” have been established for the requesting terminals 10a, 10b, 10c, and “sipnet.com” has been established as the SIP domain name. The URI that identifies the responding terminal 20 (discussed later) similarly establishes “000” as the user name “user”, and “sipnet.com” as the SIP domain name “host.” The IP addresses of the requesting terminals 10a, 10b, 10c have been set respectively to “10.0.01”, “10.0.02”, and “10.0.03”; while the IP addresses of the responding terminal 20 and the file receiving service terminal 30 have been set respectively to “20.0.0.1” and “20.0.0.2.”

The connection request module 106 has a function that, in the event that the terminal itself is a connection request source terminal that is requesting a connection, will generate connection information that includes the URI of a connection request destination terminal to which connection is requested, as well as the URI of the connection request source terminal; and will send the connection information so generated to the SIP server 40.

The connection verification module 110 receives connection information sent from the connection request destination terminal, and if the received connection information is a connection refusal response, will suspend the connection process; or if the received connection information is a connection acceptance response, will execute setting up of a session with the connection request destination terminal on the basis of the received connection information. The meaning of “setting up of a session” will be explained later.

The file transfer module 112 executes file transfer on the basis of a connection acceptance response received by the connection verification module 110. File transfer will employ a type of data transfer protocol such as HTTP (Hypertext Transfer Protocol) or FTP (File Transfer Protocol), not SIP. That is, the file transfer module 112 functions as a so-called HTTP client or FTP client. In the description below, it is assumed that file transfer takes place using HTTP.

File transfer from the requesting terminal 10 will not be actually executed with the responding terminal 20, but rather with the file receiving service terminal 30, discussed later. In other words, the file receiving service terminal 30 is a device for receiving and storing files instead of the responding terminal 20. The file receiving service terminal 30 will be hereinafter referred to as “proxy receiver 30” or “substitute receiver 30.”

The connection disconnect module 114 terminates communication among connected terminals. Specifically, in the event that the terminal itself is the connection request source terminal, the module will make a disconnect request that will be sent to the connection request destination terminal via the SIP server 40 and that contains disconnect request information including the URI of the connection request destination terminal, as well as its own URI. On the other hand, in the event that the terminal itself is the connection request destination terminal, if the module receives a disconnect request sent from the SIP server 40, it will send back to the SIP server 40 a disconnect acceptance indicating that disconnection is accepted, whereupon a disconnect acceptance response will be send back to the terminal that sent the disconnect request (the connection request source terminal).

The transfer management module 116 has a function that, once transmission/reception of a single file has finished, will temporarily disconnect the connection between terminals, and if there is still any additional file to be sent next, will initiate a new connection by the connection request module 106 for the purpose of transferring the file.

The retransmission management module 118 has a function that, in the event that a connection request made by the connection request module 106 is rejected by the connection request destination terminal because the destination terminal is busy, will compute the average time interval needed for file transfer up to that point (average send time); and once this time interval has elapsed will retry the connection request process through file transfer process. Retries can be carried out until a predetermined number of iterations is reached.

The storage module 120 stores in memory the URI that has been assigned to itself, transmitted files, received files, and information of various kinds.

The control panel 122 has dials or buttons, a keyboard, a display screen etc., and used for specifying file transfer commands and so on.

The connection response module 108 has a function that, in the event that the terminal itself is the connection request destination terminal, will receive the connection information sent from the connection request source terminal via the SIP server 40. Then, in the event that successful session setup and connection prove possible, the connection response module 108 will generate connection information (hereinbelow also termed “connection acceptance response information”) that includes status information indicating acceptance of the connection, the URI of the connection request source terminal, its own URI, and the IP address indicating the file transfer destination, and send the connection acceptance response to the connection request source terminal via the SIP server 40. On the other hand, if the connection is to be refused, the connection request source terminal 108 will generate connection information (hereinbelow also termed “connection refusal response information”) that includes status information indicating refusal of the connection, the URI of the connection request source terminal, and its own URI, and send the connection refusal response to the connection request source terminal via the SIP server 40.

### A2. Responding Terminal

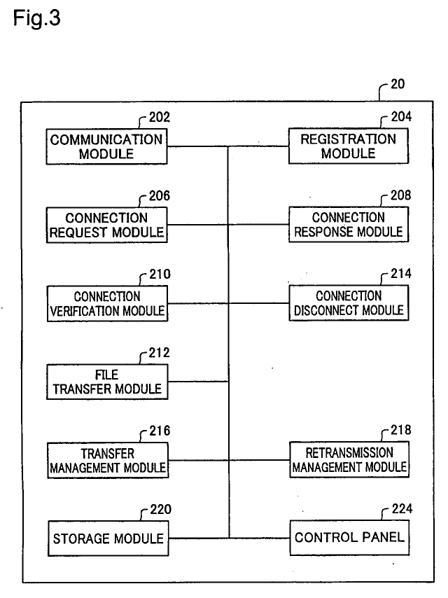

FIG. 3 is a block diagram depicting the main components of the responding terminal 20 in FIG. 1. The responding terminal 20 is also constituted by a computer system, and has a number of function blocks for carrying out various processes and controls. Specifically, as shown in FIG. 3, there are provided the function blocks of a communication module 202, a registration module 204, a connection request module 206, a connection response module 208, a connection verification module 210, a file transfer module 212, a connection disconnect module 214, a transfer management module 216, a retransmission management module 218, a storage module 220, and a control panel 222. The functions performed by these function blocks are the same as those performed by these function blocks of the requesting terminals 10, and as such require no further description.

### A3. SIP Server

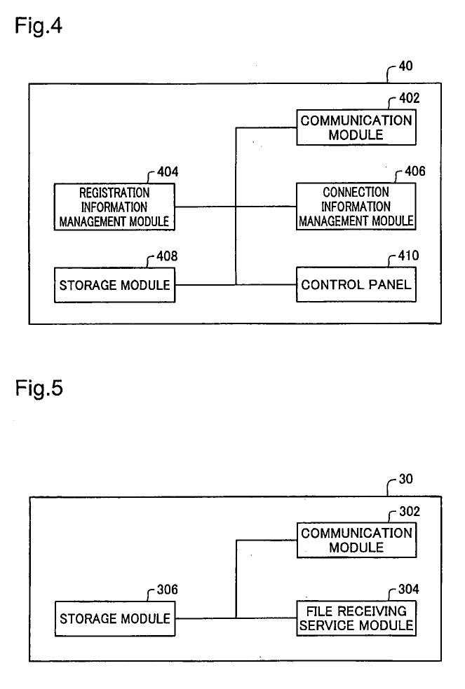

FIG. 4 is a block diagram depicting the main components of the SIP server 40 in FIG. 1. The SIP server 40 is constituted by a server computer, and has a number of function blocks for carrying out various processes and controls. Specifically, there are provided the function blocks of a communication module 402, a registration information management module 404, a connection information management module 406, a storage module 408, and a control panel 410. The communication module 402, the storage module 408, and the control panel 410 have functions comparable to the communication module, the storage module, and the control panel of the requesting terminals 10 and the responding terminal 20, and as such require no further description.

The registration information management module 404 receives registration information sent from the terminals, and saves the information in memory areas included in the storage module 408 by the storage module 408.

The connection information management module 406 receives connection requests sent from terminals, and that in the event that the URI of the connection request destination terminal included in the received connection request is a specific URI indicating a terminal capable of simultaneous file transfer from multiple terminals, will transfer the connection request to the connection request destination terminal, even if the connection request destination terminal already has an existing connection with another terminal or terminals. In transferring the connection request to the connection request destination terminal, the module 406 searches the terminal registration information for the terminals, which has been registered in the memory areas of the storage module 408, in order to acquire IP address information corresponding to the URI of the connection request destination terminal that was included in the received connection request, and then transfer the connection request to the acquired IP address. The SIP server 40 can recognize the aforementioned specific URI by referring to the terminal registration information which is registered in the SIP server 40 by the connection request destination terminal (the registration module 204 of the responding terminal 20); the register information includes the capability of the terminal 20 to connect with multiple terminals.

### A4. File Receiving Service Terminal

FIG. 5 is a block diagram depicting the main components of the file receiving service terminal 30 in FIG. 1. The file receiving service terminal 30 is also constituted by a server computer, and has a number of function blocks for carrying out various processes and controls. Specifically, as shown in FIG. 5, there are provided the function blocks of a communication module 302, a file receiving service module 304, and a storage module 306. The communication module 302 has a function comparable to the communication module of the requesting terminals 10, the responding terminal 20, and the SIP server 40, and as such requires no further description.

The file receiving service module 304 receives files sent from a requesting terminal 10 executing a file transfer. As noted, file transfer from requesting terminals 10 is carried out according to HTTP or FTP, and the file receiving service module 304 acts as a so-called HTTP server or FTP server.

The file receiving service module 304 also manages connection status information that includes a maximum number of connections indicating the maximum number of simultaneous connections possible for the file receiving service terminal 30, and a number of connections indicating the number of terminals currently connected to the file receiving service terminal 30. Here, the maximum number of simultaneous connections possible for the file receiving service terminal 30 denotes the maximum number of connections of the terminal 30 as a substitute receiver for the responding terminal 20.

The storage module 306 stores transferred files, and various types of information such as the aforementioned connection status information.

### B. System Operation

As described before, in the present embodiment, a session between devices is set up using SIP, which is a type of signaling protocol; and file transfer between devices is then carried out using HTTP, which is a type of data transfer protocol. In the following description of operation of the system, it is assumed that a session is set up between a requesting terminal 10 as a connection request source terminal and the responding terminal 20 as the connection request destination terminal; and that files sent from the requesting terminal 10 as the connection request source terminal are actually received and stored by the substitute receiver 30 for the responding terminal 20 as the connection request destination terminal. Here, the “setting up of a session” in the present embodiment means to make it possible to transfer files from the requesting terminal 10 to the substitute receiver 30, and it has a different meaning from the same words “setting up of a session” in the customary SIP protocol that mean to make it possible to transfer data directly between the requesting terminal 10 and the responding terminal 20. It can be thought that the SIP protocol used in the present embodiment is extended in this point.

### B1. Operation in Requesting Terminal

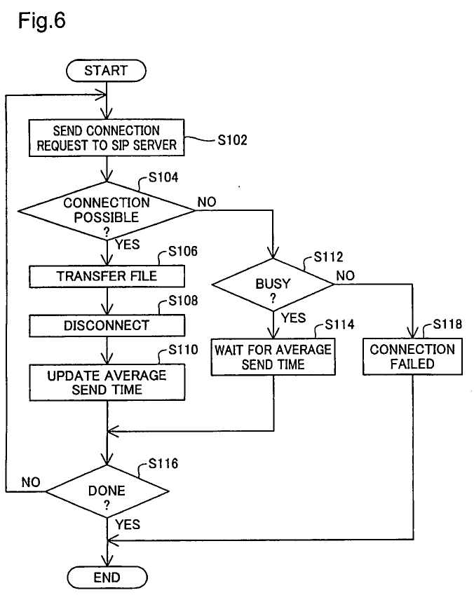

FIG. 6 illustrates a process executed by a requesting terminal 10 for sending a file. It is here assumed that the requesting terminal 10 (FIG. 2) which is the connection request source terminal, and the responding terminal 20 (FIG. 3) which is the connection request destination terminal, have periodically notified the SIP server 40 (FIG. 4) of their registration information, and registered their respective URI and IP addresses from their startup. It is also assumed that prior to initiation of the process shown in FIG. 6, the requesting terminal 10 have stored the file or files for transfer in its memory module 120. Here, the files to be transferred can be any of various kinds of files such as files scanned by a scanning function (not shown), or files read from some other storage medium.

The process of sending a file depicted in FIG. 6 will be initiated when the user operates the control panel 124 of the requesting terminal 10 and instructs file transfer toward the responding terminal 20. This instruction may be input, for example, by dialing a number as the user identifier “user” which is part of the URI of the responding terminal 20; or by pressing a one-touch button with which the URI or the responding terminal has been registered in advance.

First, the connection request module 106 generates connection information that includes the URI of the responding terminal 20 which has been specified as the connection request destination terminal, and the URI of the requesting terminal 10 which is the connection request source terminal; then send the generated connection information to the SIP server 40 to make a connection request (Step S102).

The connection verification module 110 will then receive the connection information that is returned via the SIP server 40 from the responding terminal 20 which is the connection request destination terminal, and decide whether it is possible to set up a session with the responding terminal 20 (Step S104). If the connection information is a connection acceptance response (Step S104: YES), the file transfer module 112 will then execute transfer of the file (Step S106). In this case, the destination to which the file is sent by the file transfer module 112 will be the file receiving service terminal 30 as the substitute receiver, not the responding terminal 20. Specifically, as noted, in the connection information that was sent by way of accepted connection response information, the IP address of the substitute receiver 30 (“20.0.0.2”) is written as the file transfer destination information, and the file transfer module 112 will execute HTTP file transfer to the substitute receiver 30 which corresponds to this address.

When the file transfer by the file transfer module 112 is complete, the connection disconnect module 114 will execute disconnection of the connection with the responding terminal 20 (Step S108).

Once disconnection has been executed, the transfer management module 116 will update the average send time which is stored in memory in the storage module 120 (Step S110). This average send time can be derived easily, by measuring in advance the time needed to send the file.

The transfer management module 116 will then decide whether to continue sending files (Step S116). In the event there are any remaining unsent files, and sending of files will continue (Step S116: YES), the routine will go back to Step S102 and the process will be repeated. On the other hand, if there are no remaining unsent files, and sending of files will not continue (Step S116: NO), the process will terminate.

As will be appreciated from the above description, in the event that there are multiple files for transfer, connection request, file transfer, and disconnect will be repeated on an individual file unit basis.

In Step S104, if the connection information sent from the responding terminal 20 via the SIP server 40 is a connection refusal response (Step S104: NO), it will then further be decided whether connection was refused due to the responding terminal 20 which is the connection request destination terminal (more specifically, the substitute receiver 30) having existing connections with a number of terminals equal to the maximum number of connections for the substitute receiver 30 (Step S112). At this time, in the event that connection has been refused due to existing connections with a number terminals equal to the maximum number of connections (Step S112: YES), the retransmission management module 118 will acquire the average send time from the storage module 120, and for a time interval equivalent to the average send time will suspend the process and wait (Step S114). Then, after waiting for a time interval equivalent to the average send time, it will return to Step S102 and again send a connection request to the connection request module 106. If on the other hand the connection information is a connection refusal (Step S104: NO), but the substitute receiver 30 for the responding terminal 20 which is the connection request destination terminal has not reached the maximum number of connectable terminals and is still in the connection-enabled state (Step S112: NO), it will be decided that a connection failure has occurred (Step S118), and the process will be terminated at that point. It can be readily determined from the status included in the connection information sent from the responding terminal 20 via the SIP server 40 whether the substitute receiver 30 for the responding terminal 20 is currently connected to other terminals, and whether it is connectable to another terminal.

### B2. Operation in SIP Server

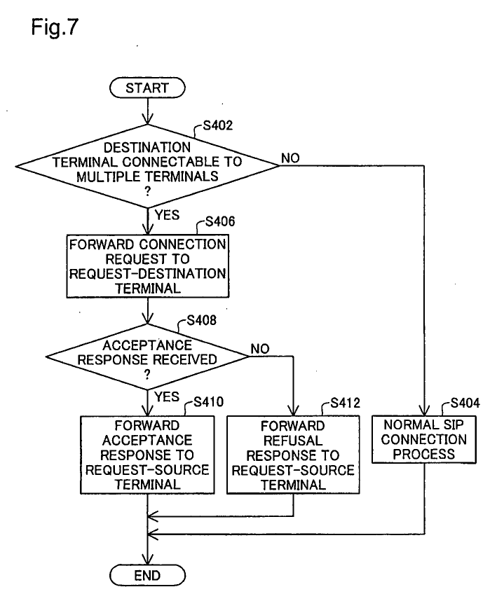

FIG. 7 illustrates a process executed by the SIP server 40 in sending a file from a requesting terminal 10 to the substitute receiver 30 of the responding terminal 20. This process will be executed each time that the requesting terminal 10 sends a connection request to the SIP server 40.

First, on the basis of connection request, the connection information management module 406 of the SIP server 40 will decide whether the connection request is directed to a connection request destination terminal that is capable of connecting with multiple terminals (Step S402). As noted previously, where the registration information from a connection request destination terminal contains information indicating that it is capable of connecting with multiple terminals, it can be decided that the connection request is one directed to a terminal connectable with multiple terminals; and if not, it can be decided that the connection request is one directed to a terminal not connectable with multiple terminals.

If the destination terminal is one that is not connectable with multiple terminals (Step S402: NO), a normal connection process will be executed in accordance with SIP (Step S404).

On the other hand, if the destination terminal is one that is connectable with multiple terminals (Step S402: YES), the connection request will be sent to the destination terminal 20 (Step S406). Transfer of this connection request to the destination terminal can be carried out by searching the registration information of the terminals registered in the memory areas in the storage module 408 to acquire the IP address for the destination terminal URI included in the received connection request, then transferring the connection request to the acquired IP address.

Next, a response is received from the responding terminal 20 as the connection request destination terminal, and it is decided whether the response is a connection acceptance response or a connection refusal response (Step S408). If the received response is a connection acceptance response (Step S408: YES), a connection acceptance response will be transferred to the requesting terminal 10 as the connection request source terminal (Step S410). If on the other hand the received response is a connection refusal response (Step S408: NO), a connection refusal response will be transferred to the requesting terminal 10 as the connection request source terminal (Step S412).

### B3. Operation in Responding Terminal

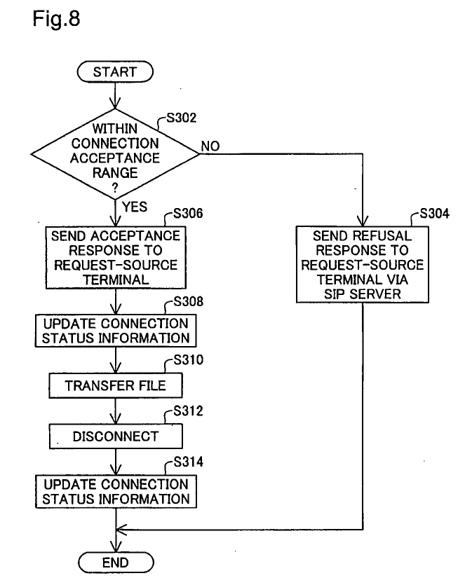

FIG. 8 illustrates a process executed by the responding terminal 20 in the event that a requesting terminal 10 executes sending of a file to the substitute receiver 30 for the responding terminal 20. This process will be executed each time that a connection request is sent from a requesting terminal 10 via the SIP server 40.

First, when a connection request is received, the connection response module 208 of the responding terminal 20 will decide whether the connection request lies within the connection acceptance range, that is, whether the connection request lies within the maximum number connections of the substitute receiver 30 (Step S302).

If the number of currently connected terminals equals the number of terminals of the connection acceptance range, it will be decided that the connection acceptance range has been exceeded (Step S302: NO), whereupon a connection refusal response will be generated; the generated connection refusal response will be sent via the SIP server 40 to the requesting terminal 10 (Step S304); and the process will terminate.

The above decision can be made by acquiring the connection status information that is stored in the storage module 306 of the substitute receiver 30 which actually receives the files; then comparing the current number of connections with the maximum number of connections included in the connection status information. The maximum number of connections refers to the maximum number of terminals able to be connected simultaneously (connection acceptance range); the current number of connections refers to the number of currently connected terminals. Consequently, if the maximum number of connections is equal to the current number of connections, it can be determined that an additional connection request will exceed the connection acceptance range; and if the maximum number of connections is greater than the current number of connections, it can be determined that an additional connection request will fall within the connection acceptance range.

If the current number of connections is less than the maximum number of connections of the substitute receiver 30, it will be decided that the additional connection request falls within the connection acceptance range (Step S302: YES), whereupon a connection acceptance response will be generated and sent via the SIP server 40 to the requesting terminal 10 (Step S306). The number of connections indicated in the connection status information that is stored in the storage module 306 of the substitute receiver 30 will then be incremented by 1 (Step S308). The connection acceptance response describes, as the file transfer destination, the IP address of the substitute receiver 30 (“20.0.0.2”) that actually receives files.

As discussed above, when a session is set up between a requesting terminal 10 as a connection request source terminal and the responding terminal 20 as a connection request destination terminal, the file receiving service module 304 of the substitute receiver 30 which is the actual file recipient will receive files sent to it by HTTP from the requesting terminal 10 that is the file sender (Step S310). Files received by substitute receiver 30 will be stored in the storage module 306. The received files are not necessarily transferred to the responding terminal 20, and in typical cases they are simply stored in the substitute receiver 30. The files stored in the substitute receiver 30 may be arbitrarily read out if needed.

In the substitute receiver 30, during storage in the storage module 306 of a file received by the file receiving service module 304, it will be preferable to save the file under a file name that includes the user name of the URI of the file sender. For example, where the file name of a file sent by the first requesting terminal 10a is “xxxx.jpg”, it would be saved with a file name that includes the user name of the URI of the first requesting terminal 10a, such as “001@sipnet.xxxx.jpg.” By so doing, in the event that the file needs to be modified and then returned to the terminal 10afor example, the URI of the return destination can be easily identified from the file name, thereby affording a simpler operation and making it possible to avoid misidentification of the return destination.

Once sending of the file from the requesting terminal 10 is finished, and a disconnect request has been received from the requesting terminal 10 via the SIP server 40, the connection disconnect module 214 will execute a connection disconnect process (Step S312). The number of connections indicated in the connection status information that is stored in the storage module 306 of the substitute receiver 30 will then be decremented by 1 (Step S314), and the process will terminate.

### B4. Overall System Operation

Following is a description of operation of the system as a whole, taking the example of an instance where the three requesting terminal 10a, 10b, and 10c, in that order, make connection requests to the responding terminal 20 for the purpose of file transfer. In the following description, the maximum number of connections of the substitute receiver 30 is assumed to be “2”; and at the point in time that the third requesting terminal 10c issues a connection request to the responding terminal 20, the firs and second requesting terminal 10a, 10b are currently connected to the responding terminal 20.

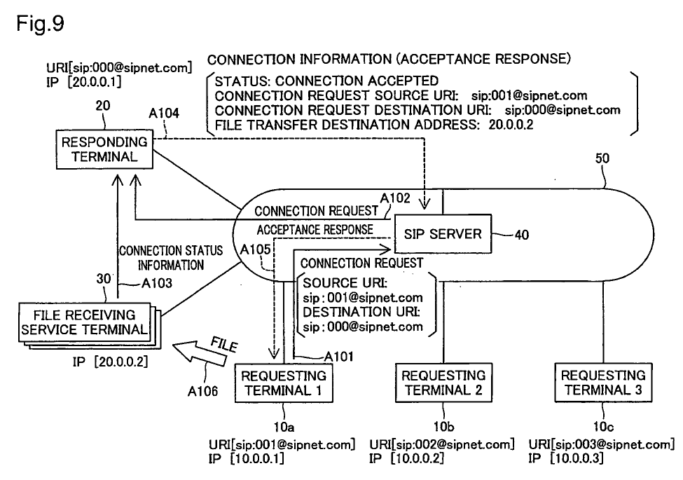

FIG. 9 is an illustration depicting overall system operation where the requesting terminal 10a has issued a connection request.

The requesting terminal 10a that is the first connection request source terminal will first send the SIP server 40 connection information indicating a connection request (hereinafter simply referred to as “connection request”), as shown with solid arrow A101. The connection request will include the URI of the connection request source terminal itself (“sip:001@sipnet.com”) and the URI of the responding terminal 20 which is the connection request destination terminal (“sip:000.sipnet.com”).

Having received the connection request, the SIP server 40 will now decide that the URI for the responding terminal 20 (the connection request destination terminal), which has been included in the received connection request, is a particular URI to which multiple simultaneous terminal connections are allowed, and will forward the received connection request to the responding terminal 20 as shown with solid arrow A102.

Having received the connection request, the responding terminal 20 will now acquire connection status information from the substitute receiver 30 as shown with solid arrow A103. It will then compare the current number of connections “0” to the maximum number of connections “2” of the substitute receiver 30 included in the acquired connection status information. Here, since the number of connections is fewer than the maximum number of connections, connection information indicating a connection acceptance response (hereinafter simply referred to as “connection acceptance response”) will be sent to the SIP server 40 as shown with solid arrow A104. The connection acceptance response will include status information indicating connection acceptance; the URI of the requesting terminal 10a that is the connection request source terminal (“sip:001@sipnet.com”); the URI of the responding terminal 20 which is the connection request destination terminal itself (“sip:000.sipnet.com”); and the IP address (“20.0.0.2”) of the substitute receiver 30 which is the file transfer destination.

Having received the connection acceptance response, the SIP server 40 will now forward the received connection acceptance response to the first requesting terminal 10a which is the connection request source terminal as shown with dashed arrow A105. As a result, the first requesting terminal 10a will receive the connection acceptance response sent from the SIP server 40.

In the above manner, a session will be set up between the first requesting terminal 10a and the responding terminal 20, when the first requesting terminal 10a issues a connection request to the responding terminal 20 via the SIP server 40 and in turn receives a connection acceptance response from the responding terminal 20 via the SIP server 40. As described before, the “setting up of a session” in the present embodiment means to make it possible to transfer files from the requesting terminal 10 to the substitute receiver 30, and it has a different meaning from the same words “setting up of a session” in the customary SIP protocol that mean to make it possible to transfer media data stream directly between the requesting terminal 10 and the responding terminal 20.

Once the session has been set up between the first requesting terminal 10a and the responding terminal 20, on the basis of the IP address of the substitute receiver 30 acquired from the connection acceptance response the first requesting terminal 10a will transfer files by HTTP to the substitute receiver 30 through direct access, rather than through the SIP server 40 as shown with white arrow A106.

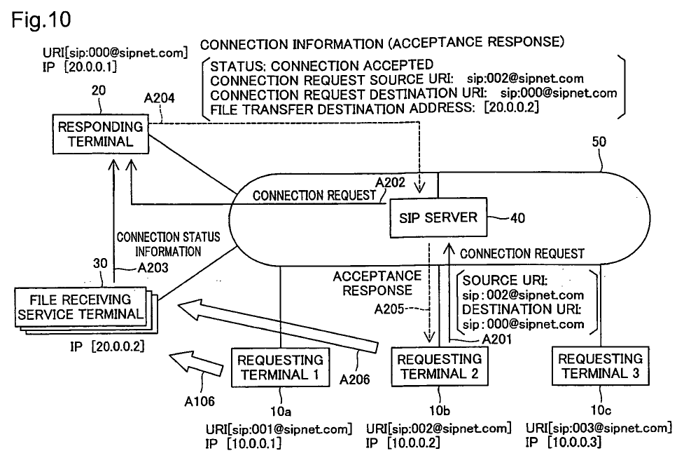

FIG. 10 is an illustration depicting overall system operation where the requesting terminal 10b as the second connection request source terminal has issued a connection request.

As noted before, the maximum number of connections of the substitute receiver 30 is assumed to be “2”, and thus the requesting terminal 10b as the second connection request destination terminal will be able to obtain a simultaneous connection. Consequently, as depicted in FIG. 10, like the first requesting terminal 10a, the requesting terminal 10b will be able to set up a session with the responding terminal 20 via the SIP server 40 as shown with solid arrows A201-A203 and dashed arrows A204, A205, and will be able to transfer files by HTTP to the substitute receiver 30 through direct access, rather than through the SIP server 40 as shown with white arrow A206.

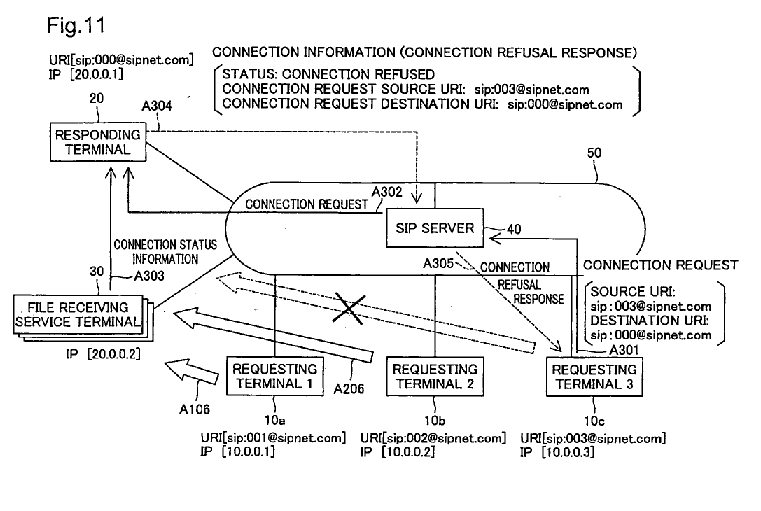

FIG. 11 is an illustration depicting overall system operation where the requesting terminal 10c as the third connection request source terminal has issued a connection request.

Since the first and the second requesting terminals 10a, 10b are currently connected to the responding terminal 20, the number of connections included in the connection status information that the responding terminal 20 acquires from the substitute receiver 30 will be “2”, which is equal to the maximum number connections of the substitute receiver 30. In this case, the third requesting terminal 10c will not be able to obtain a connection, as described below.

In the same way as the other requesting terminals, the third requesting terminal 10c will first issue a connection request to the responding terminal 20 via the SIP server 40 as shown with solid arrows A301, A302.

Having received the connection request, the responding terminal 20 will now acquire connection status information from the substitute receiver 30 as shown with solid arrow A303. It will then compare the current number of connections “2” to the maximum number of connections “2” of the substitute receiver 30 included in the acquired connection status information. Here, since the current number of connections equals the maximum number of connections, connection information indicating a connection refusal response (hereinafter simply referred to as “connection refusal response”) will be sent to the SIP server 40 as shown with solid arrow A304. The connection refusal response will include status information indicating connection refusal; the URI of the requesting terminal 10c that was the connection request source terminal (“sip:003@sipnet.com”); and the URI of the responding terminal 20 which is the connection request destination terminal itself (“sip:000.sipnet.com”).

Having received the connection refusal response, the SIP server 40 will now forward the received connection refusal response to the third requesting terminal 10c as the connection request source terminal as shown with dashed arrow A305. As a result, the third requesting terminal 10c will receive the connection refusal response sent from the SIP server.

In the above manner, if the third requesting terminal 10c has issued a connection request to the responding terminal 20 via the SIP server 40, it will receive a connection refusal response from the responding terminal 20 via the SIP server 40. In this case, a session cannot be set up between the third requesting terminal 10c and the responding terminal 20, so the third requesting terminal 10c will not be able to transfer files. In this case, the responding terminal 20 uses two different URIs, that is, an URI for the SIP protocol and another URI for the substitute receiver, in order to execute the above described process.

However, as described above in the section “B1. Operation in Requesting Terminal”, the third requesting terminal 10c can proceed with the process after waiting for an interval equivalent to average send time, and reattempt to set up a session. If, when a connection request is reissued, the current number of connections is now less than the maximum number of connections, the third requesting terminal 10c will also be able to set up a section and carry out file transfer.

### C. Advantages of the Embodiment

In the present embodiment, a session between a requesting terminal 10 as a connection request source terminal and the responding terminal 20 as a connection request destination terminal is first set up via the SIP server using SIP, which is a type of signaling protocol; and file transfer between the requesting terminal 10 and the substitute receiver 30 is then carried out using HTTP, which is a type of data transfer protocol, whereby transfer of files between the requesting terminal 10 and the substitute receiver 30 can take place directly without going through the SIP server.

If the SIP server 40 has received a connection request from a requesting terminal 10 as a connection request source terminal, it can forward the received connection request to the responding terminal 20 even if the responding terminal 20 which is the connection request destination terminal has already set up a session with and is currently connected to another requesting terminal 10 as a connection request source terminal. The responding terminal 20 can then issue a connection acceptance response and set up a session, until the maximum number of requesting terminals from which the substitute receiver 30 is capable of receiving files sent by HTTP is reached.

It is accordingly possible to carry out simultaneous high-speed file transfer from a plurality of requesting terminals to a given particular terminal (the substitute receiver of a responding terminal) on a communication platform in which a signaling protocol is employed as the protocol for setting up a session between terminals.

The files transferred from requesting terminals 10 that are connection request source terminals is not received by the responding terminal 20 that is the connection request destination terminal, but rather by the substitute receiver 30 whose IP address is included in the connection acceptance response returned by the responding terminal 20; it is therefore possible to increase the number of the substitute receivers 30 according to the scale of the system, e.g. the number of requesting terminals 10 that are connection request source terminals. Thus, irrespective of system scale, it will be possible to carry out simultaneous high-speed file transfer from a plurality of terminals (requesting terminals) to a given particular terminal (the substitute receiver of the responding terminal).

Moreover, even if a requesting terminal 10 as a connection request source terminal has a plurality of files needing to be transferred, the connection between terminals will be disconnected each time when a single file is transferred, then a new connection request will be made and a session set up. Thus, the time interval taken up by the connection between the responding terminal 20 and that particular requesting terminal 10 alone can be reduced, and opportunities for other requesting terminals 10 to set up a session and transfer files can be increased. Thus, file transfers can be carried out in leveled manner throughout the system as a whole, and satisfaction level of system utilization can be improved.

Furthermore, in the event that the responding terminal 20 as a connection request destination terminal has issued a connection refusal response due to the fact that the responding terminal 20 has existing connections with other requesting terminals 10, a requesting terminal 10 as an additional connection request source terminal can calculate average time taken by file transfers up to that point, and after allowing this average time to elapse, can reissue a connection request up to a given number of times. By reissuing a connection request after the average time has elapsed, there is a higher likelihood of making a connection request at timing coincident with termination of a connection with another requesting terminal 10 that is currently connected, and the likelihood of being able to connect will be improved.

### D. Modified Embodiments

The present invention is not limited to the embodiment described herein, and may be embodied with various changes without departing from the spirit and scope of the invention.

While the embodiment above described by way of example a case in which the requesting terminals 10, the responding terminal 20, and the substitute receiver 30 are present within the same domain as the SIP server 40, no particular limitation is imposed thereby, and it would be acceptable for the requesting terminals 10, the responding terminal 20, and the substitute receiver 30 to be respectively present in different domains.

While the embodiment above described by way of example a case in which the substitute receiver 30 is a separate terminal different from the responding terminal 20, it would be possible for the responding terminal 20 to be furnished with the functions of the substitute receiver 30.

In the embodiment above, a broadband network, that may include the Internet, is used as the network, but it would also be possible to use a mobile phone network or public phone network.

While the embodiment above employs SIP, which is one type of signaling protocol, the present invention is not limited thereto, and could instead employ other protocols such as H.323, MGCP (Media Gateway Control Protocol), and MEGACO (Media Gateway Control).

### E. Other Application Examples

The present invention may be also embodied as the following application examples.

Application example A10: A file transfer system for transferring files over a network, comprising:

a plurality of transfer requesting terminals connected on the network;

a transfer responding terminal connected on the network; and

a mediating server connected on the network, the mediating server mediating session setup between the transfer requesting terminals and the responding terminal, wherein

if a transfer responding terminal sends, to the mediating server via the network according to a signaling protocol, connection request information that indicates a request for session setup with the transfer responding terminal, the mediating server forwards the connection request information to the transfer responding terminal via the network irrespective of whether a session has been set up between any one of the transfer requesting terminals and the transfer responding terminal,

the transfer responding terminal returns connection response information to the mediating server via the network that indicates a connection acceptance response and that includes location information indicating a file transfer destination on the network if a number of connections for which a session has already been established is less than a maximum number of possible simultaneous connections, or the transfer responding terminal returns connection response information to the mediating server that indicates a connection refusal response if the number of connections is equal to the maximum number,

the mediating server which received the connection response information from the transfer responding terminal forwards the connection response information to the transfer requesting terminal that originally sent the connection request information, and

the transfer requesting terminal which received the connection response information sends a file to the transfer destination indicated by the location information included in the connection response information in accordance with a data transfer protocol if the connection response information indicates the connection acceptance response.

Application example A11: The file transfer system according to application example A10, wherein

if the connection response information indicates a connection refusal response, the transfer requesting terminal resends the connection request information after a prescribed time interval has elapsed.

Application example A12: The file transfer system according to application example A11, wherein the transfer requesting terminal terminates the session with the responding terminal after completion of transfer of the file, and

if there is any other file remaining to be sent after termination of the session with the transfer responding terminal, the transfer requesting terminal resends connection request information to the mediating server via the network.

Application example A13: The file transfer system according to application example A11, wherein

the prescribed time interval is an average value of time required for transfer of files in the transfer requesting terminal that received the connection response information indicating the connection refusal response.

Application example A14: The file transfer system according to application example A10, wherein

the location information indicative of the file transfer destination indicates a network location different from that of the transfer responding terminal.

Application example A15: The file transfer system according to application example A10, wherein

the signaling protocol is SIP (Session Initiation Protocol).

Application example A16: The file transfer system according to application example A10, wherein

the data transfer protocol is HTTP (Hypertext Transfer Protocol).

Application example A17: A file transfer method for transferring files over a network, the network including a plurality of transfer requesting terminals, a transfer responding terminal, and a mediating server, the method comprising:

sending from a transfer responding terminal to the mediating server, via the network according to a signaling protocol, connection request information that indicates a request for session setup with the transfer responding terminal;

forwarding the connection request information from the mediating server to the transfer responding terminal via the network irrespective of whether a session has been set up between any one of the transfer requesting terminals and the transfer responding terminal;

at the transfer responding terminal, returning connection response information to the mediating server via the network that indicates a connection acceptance response and that includes location information indicating a file transfer destination on the network if a number of connections for which a session has already been established is less than a maximum number of possible simultaneous connections, or returning connection response information to the mediating server that indicates a connection refusal response if the number of connections is equal to the maximum number;

forwarding the connection response information from the mediating server to the transfer requesting terminal that originally sent the connection request information; and

sending a file from the transfer requesting terminal which received the connection response information toward the transfer destination indicated by the location information included in the connection response information in accordance with a data transfer protocol if the connection response information indicates the connection acceptance response.

Application example A18: The file transfer method according to application example A17, wherein

resending, from the transfer requesting terminal which received the connection response information to the mediation server, the connection request information after a prescribed time interval has elapsed if the connection response information indicates a connection refusal response.

What is claimed is:

1. A transfer requesting terminal that is connected on a network and that constitutes a file transfer system for transferring files over the network together with a transfer responding terminal and a mediating server, wherein
the transfer requesting terminal sends to the mediating server, via the network and in accordance with a signaling protocol, connection request information that indicates a connection request for use in setting up a session with the transfer responding terminal; and
if a number of connections for which a session has already been established in the transfer responding terminal is less than a maximum number of possible simultaneous connections, and if connection response information that is sent via the mediating server from the responding terminal indicates a connection acceptance response to the connection request, the transfer requesting terminal sends a file to a file transfer destination indicated by location information included in the connection response information, in accordance with a data transfer protocol.

2. The transfer requesting terminal according to claim 1, wherein
if the connection response information indicates a connection refusal response, the transfer requesting terminal resends the connection request information after a prescribed time interval has elapsed.

3. The transfer requesting terminal according to claim 2, wherein the transfer requesting terminal terminates the session with the responding terminal after completion of transfer of the file, and
if there is any other file remaining to be sent after termination of the session with the transfer responding terminal, the transfer requesting terminal resends connection request information to the mediating server via the network.

4. The transfer requesting terminal according to claim 2, wherein
the prescribed time interval is an average value of time required for transfer of files in the transfer requesting terminal that received the connection response information indicating the connection refusal response.

5. The transfer requesting terminal according to claim 1, wherein
the location information indicative of the file transfer destination indicates a network location different from that of the transfer responding terminal.

6. The transfer requesting terminal according to claim 1, wherein
the signaling protocol is SIP (Session Initiation Protocol).

7. The transfer requesting terminal according to claim 1, wherein
the data transfer protocol is HTTP (Hypertext Transfer Protocol).

8. A transfer responding terminal that is connected on a network and that constitutes a file transfer system for transferring files over the network together with a plurality of transfer requesting terminals and a mediating server, wherein the transfer responding terminal:
if connection request information indicating a connection request for use in setting up a session with the transfer responding terminal has been sent to the mediating server by a transfer requesting terminal via the network in accordance with a signaling protocol, and the connection request information has then been forwarded via the network from the mediating server to the transfer responding terminal irrespective of whether a session has been set up between the transfer responding terminal and any one of the transfer requesting terminals, and
if a number of connections for which a session has already been established is less than a maximum number of possible simultaneous connections, the transfer responding terminal sends connection response information to the mediating server that indicates a connection acceptance response and including location information indicating a file transfer destination on the network,
else if the number of connections is equal to the maximum number of possible simultaneous connections, the transfer responding terminal sends connection response information to the mediating server that indicates a connection refusal response.

9. A mediating server that is connected on a network and that constitutes a file transfer system for transferring files over the network together with a plurality of transfer requesting terminals and a transfer responding terminal, wherein the mediating server:
if connection request information indicating a connection request for use in setting up a session with the transfer responding terminal is sent by a transfer requesting terminal via the network in accordance with a signaling protocol, the mediating server forwards the connection request information to the transfer responding terminal, irrespective of whether a session has been set up between the transfer responding terminal and any one of the transfer requesting terminals.
